(19) United States
(12) Patent Application Publication
(10) Pub. No.: US 2012/0166555 A1
(43) Pub. Date: Jun. 28, 2012

(54) METHOD AND SYSTEM FOR BROADCASTING SPORTING EVENT INFORMATION

(76) Inventor: Dave Petno, Hudson, OH (US)

(21) Appl. No.: 13/181,728

(22) Filed: Jul. 13, 2011

Related U.S. Application Data
(60) Provisional application No. 61/427,356, filed on Dec. 27, 2010.

(51) Int. Cl. G06F 15/16

(52) U.S. Cl. 709/206; 709/204

(57) ABSTRACT

A method of communicating information related to sporting event information can include the steps of accessing a website, entering sporting event information into the website, and broadcasting the first sporting event information via a plurality of emails. The first email can contain the first sporting event information in a first format and a second email can contain the first sporting event information in a second format.

### CROSS-REFERENCE TO RELATED APPLICATIONS

This application claims the benefit of U.S. Provisional Application No. 61/427,356, titled SCOREFEEDER, filed Dec. 27, 2010, which is herein incorporated by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

This invention generally relates to methods and systems of recording and broadcasting information and results related to various amateur sporting events.

2. Description of Related Art

Amateur sporting events are rarely broadcast on television or radio. Sporting events such as youth sports games, school-sponsored sporting events, amateur sports leagues, college sports, and other recreation sporting events are often attended only by friends and relatives of the players. Scoring for such games is often kept by pencil and paper and recorded by a coach or league official when the game is complete. Scoring is sometimes kept on a mobile device or laptop computer. Some coaches use computers to keep track of scores or statistics over a season. Therefore, fans of amateur sports that are unable to attend a scheduled event are often unable to easily acquire the final results of the sporting event. Moreover, local or national media outlets are often unable collect game information for distribution to news websites or newspapers unless a coach or team official contacts the local or national media directly.

Currently, fans of amateur sports must review the local newspapers or news websites searching the results of the sporting event of interest. Unfortunately, the results may not have been reported to the media outlets. In addition, some media outlets require the sporting event results to be delivered in a specific format or layout before they will report the results.

Therefore, what is needed is a method and system of recording the results of sporting events and broadcasting the results to family, friends, fans, and media outlets in a customizable format.

### BRIEF SUMMARY OF THE INVENTION

According to some embodiments, the invention can include a web based portal that allows high school and college teams or classes to store their roster data including player name, uniform number, and graduation date. The invention can generate statistical summaries of sporting event information and submit the information to a plurality of recipients, including media outlets, at virtually the same time. In some embodiments, the broadcast of the sporting event information to multiple recipients occurs upon the selection of a “Broadcast Now” button or link. In one embodiment, the broadcast of the sporting event information to multiple recipients occurs at virtually the same time upon one click of a “Broadcast Now” button. Each team or organization can be linked to one or more media outlets including, but not limited to, newspaper, radio, television, and interne. Each team or organization can also be linked to non-media recipients including, but not limited to, coaches, team representatives, family, friends, fans, and other members of the general public. Following a sporting event, sporting event information is entered via the web portal into a standard or customized template. After sporting event information has been entered, the sporting event information can be formatted into different email templates and broadcasted to the linked media outlets and non-media recipients. Each media outlet or recipient can receive an email in a standard, custom, or customized template. Each media or non-media recipient can specify or customize a format. In some embodiments, the templates are designed to the specifications of each media outlet or non-media recipient. Customized feeds can also include RSS feeds, comma delimited output, or other formats specified by the media outlets or the non-media recipients. The sporting event information can be sent out in an unlimited number of different arrangements, layouts, or formats.

According to one embodiment of this invention, a method of communicating information related to a sporting event information can include the steps of: accessing a website; entering a first sporting event information into the website; saving the first sporting event information to a database; and broadcasting the first sporting event information via a plurality of communications, wherein a first communication contains the first sporting event information in a first format and a second communication contains the first sporting event information in a second format. In some embodiments, the first and second communications are emails. The step of broadcasting the first sporting event information can further include automatically sending the first sporting event information via email after the first sporting event information has been entered. The step of broadcasting the first sporting event information can further include automatically sending the first sporting event information via email after the first sporting event information has been entered and verified. In some embodiment, the plurality of communications can be broadcast at substantially the same time or within a few seconds or minutes of each other.

The method can include arranging the first sporting event information into a first format, and arranging the first sporting event information into a second format. The method can include modifying a first email with the first sporting event information in a first format, and modifying a second email with the first sporting event information in a second format. The method can include selecting a first subset of the first sporting event information for a first format, and selecting a second subset of the first sporting event information for a second format. The method can include selecting and arranging a first subset of the first sporting event information for a first format, and selecting and arranging a second subset of the first sporting event information for a second format. The method can further include a third communication containing the first sporting event information in a third format, a fourth communication containing the first sporting event information in a fourth format, a fifth communication containing the first sporting event information in the first format, and a sixth communication containing the first sporting event information in the second format.

According to another embodiment of this invention, a method of communicating information related to a sporting event information can include the steps of: accessing a website; associating a first recipient to a first organization and a second recipient to a second organization; entering a first sporting event information for the first and second organizations into the website; and broadcasting the first sporting event information to a plurality of recipients, wherein the first recipient receives a first communication with the first sporting event information in a first format and the second recipient receives a second communication with the first sporting event information in a second format. In some embodiments, the first and second communications are emails. The method can further include associating a first media outlet with a first organization; associating a second media outlet with a second organization; associating a third media outlet with the first organization; associating a fourth media outlet with the second organization; entering a first sporting event information for the first and second organizations; and broadcasting the first sporting event information to a plurality of recipients, wherein the first media outlet receives a third communication containing the first sporting event information in a third format, the second media outlet receives a fourth communication containing the first sporting event information in a fourth format, the third media outlet receives a fifth communication containing the first sporting event information in the fourth format, and the fourth media outlet receives a sixth communication containing the first sporting event information in the third format.

According to another embodiment of this invention, a system for communicating info nation related to sporting events can include: a server hosting a website; a database in communication with the server containing a plurality of sporting event information including a first sporting event information; and an email server in communication with the database; wherein the email server can send a first email with the first sporting event information in a rust format and a second email with the first sporting event information in a second format. The email server can create the first format based upon a first setting and the second format based upon a second setting. The first format can include a first subset of the first sporting event information, and the second format can include a second subset of the first sporting event information. The first format can include a first arrangement of the first sporting event information, and the second format can include a second arrangement of the first sporting event information.

One advantage of this invention is that sporting event results are easily recorded. Another advantage of this invention is that family, friends, fans, and media outlets can receive sporting event results in an individualized layout or format after the results are recorded.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 illustrates a diagram of a system for communicating information related to sporting events, according to one embodiment;

FIG. 2 illustrates a home web page of a host website, according to one embodiment;

FIGS. 3A and 3B illustrate a new account web page for a team representative, according to one embodiment;

FIGS. 4A-4E illustrate a home page and reporting scores and statistics web pages for the team representative, according to one embodiment;

FIG. 5 illustrates a manage rosters web page of the host website, according to one embodiment;

FIG. 6 illustrates a manage authorized users web page of the host website, according to one embodiment;

FIGS. 7A and 7B illustrate web pages related to the managing the recipients of the information, according to one embodiment;

FIGS. 8A-8H illustrate web pages related to broadcasting scores to recipients, according to one embodiment;

FIG. 9 illustrates a web page related to the public subscription, according to one embodiment;

FIGS. 10A-10E illustrate a software utility for managing verified media sources and standard media sources, according to one embodiment.

### DETAILED DESCRIPTION OF THE INVENTION

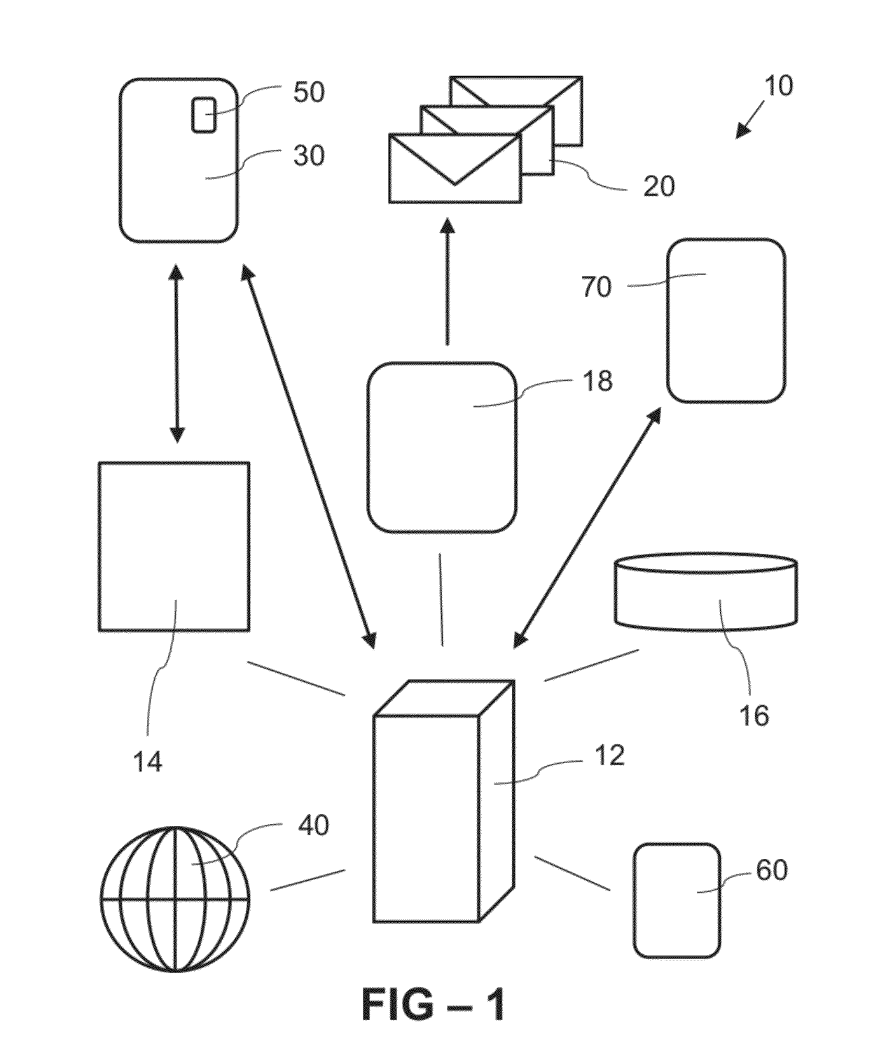

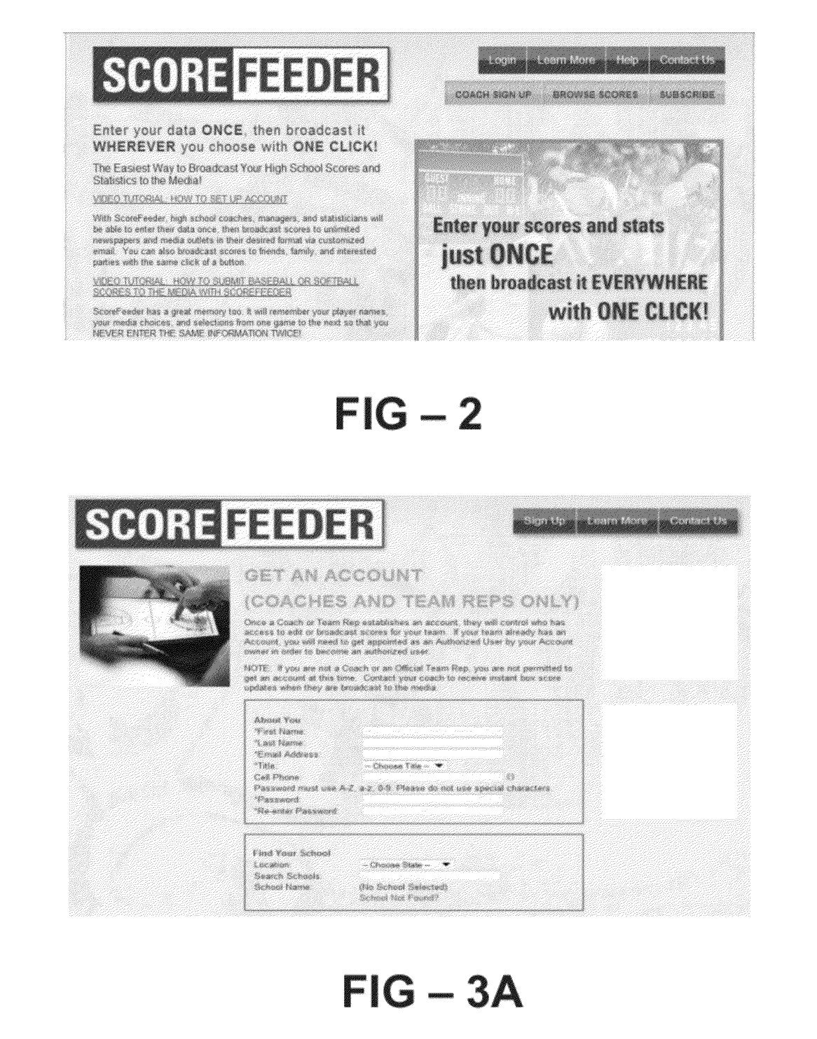

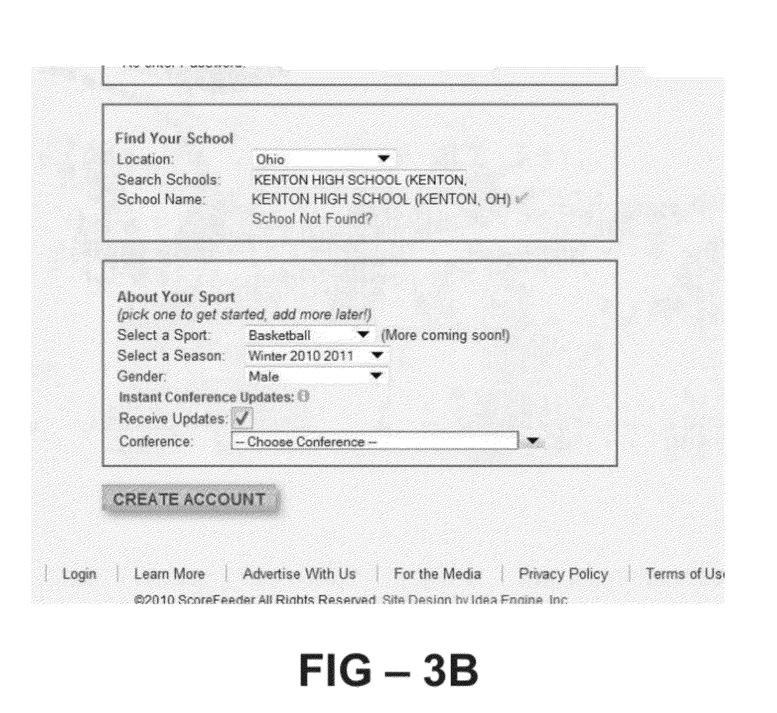

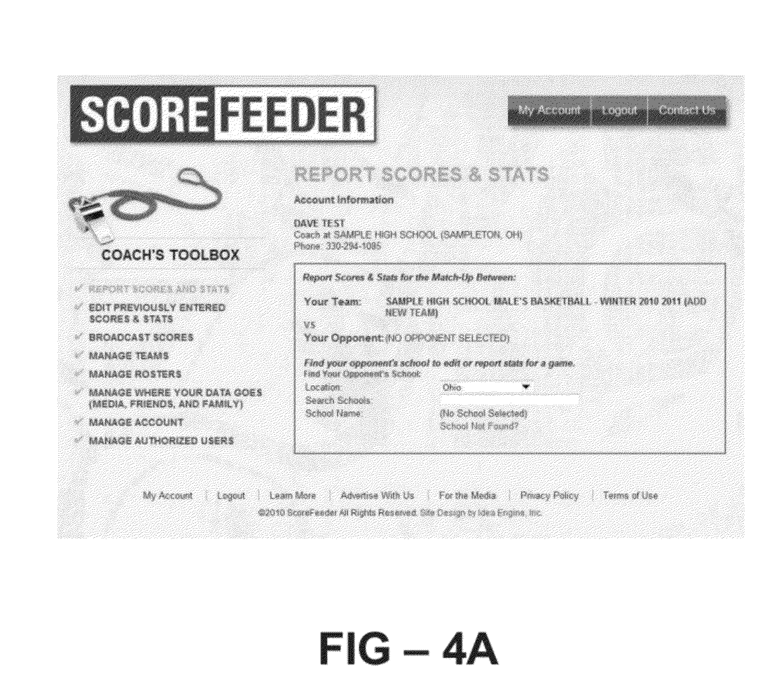

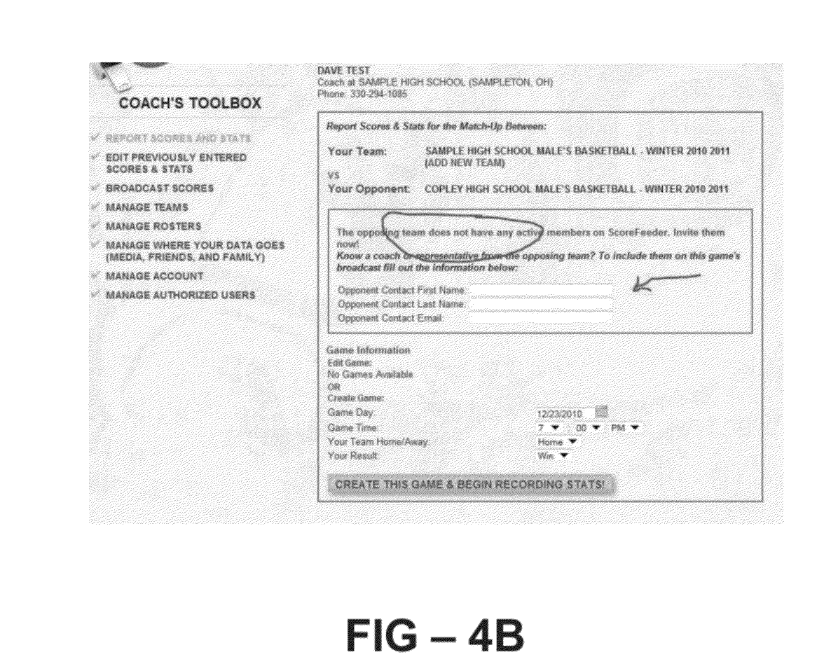

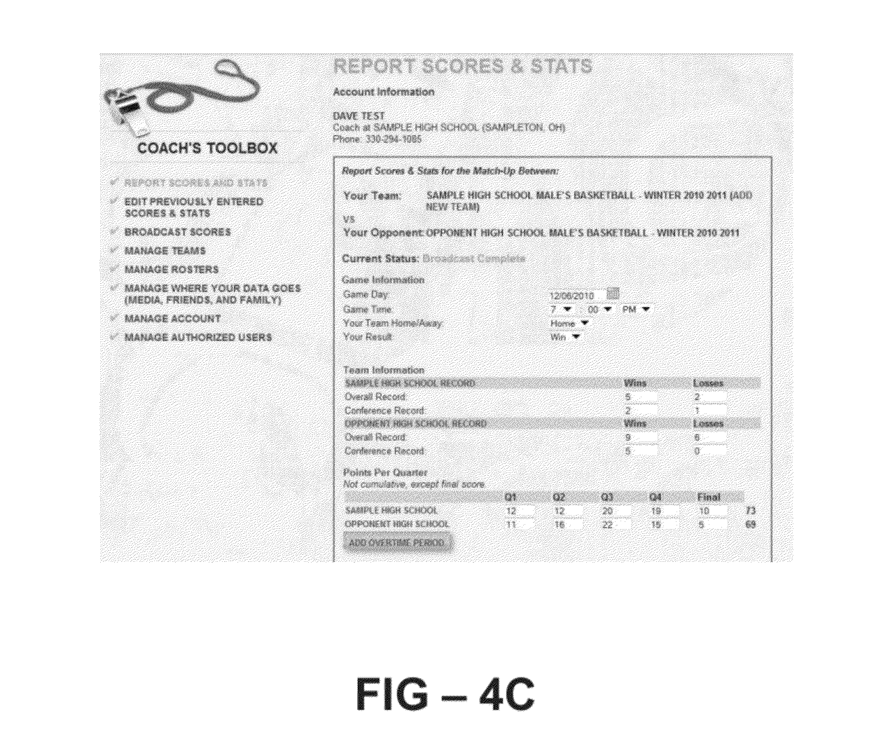

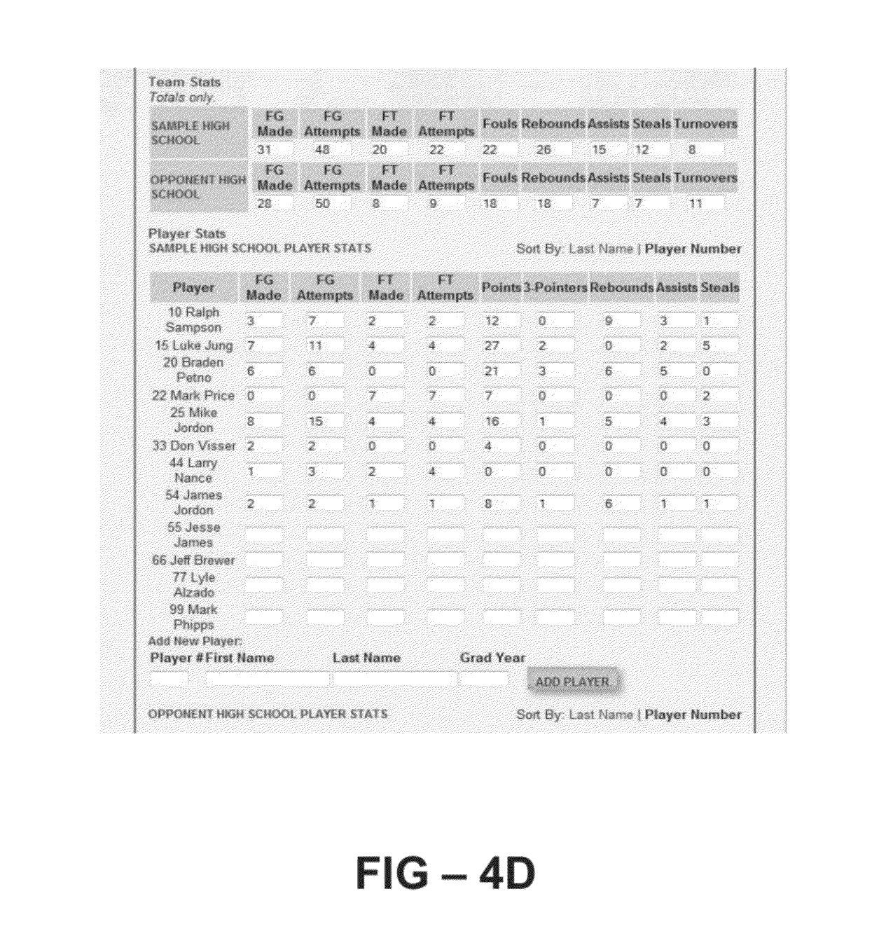

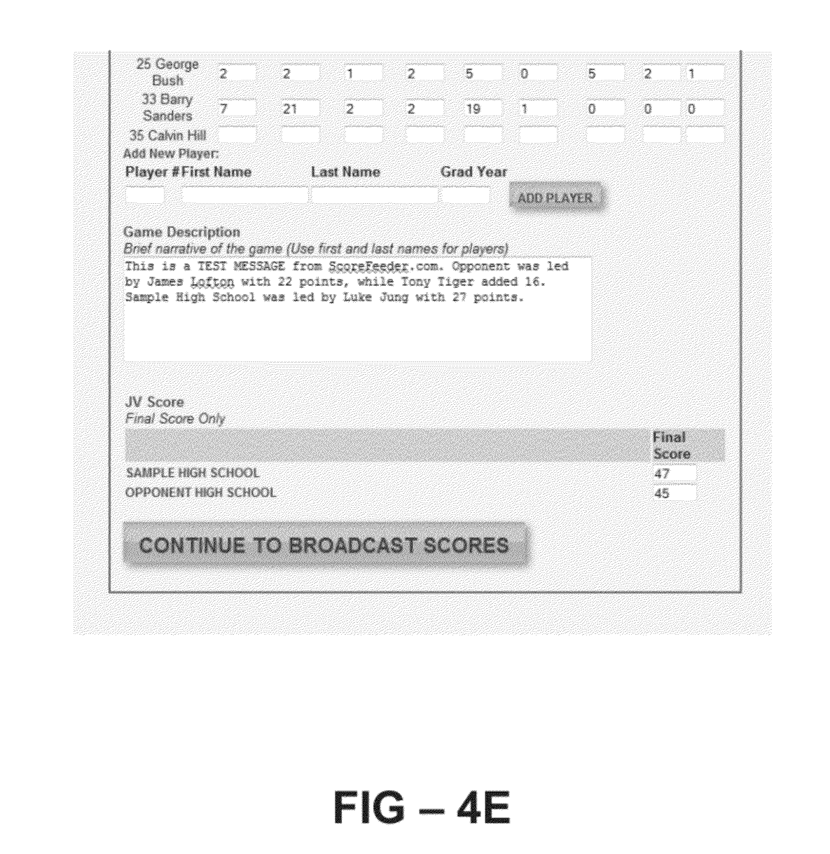

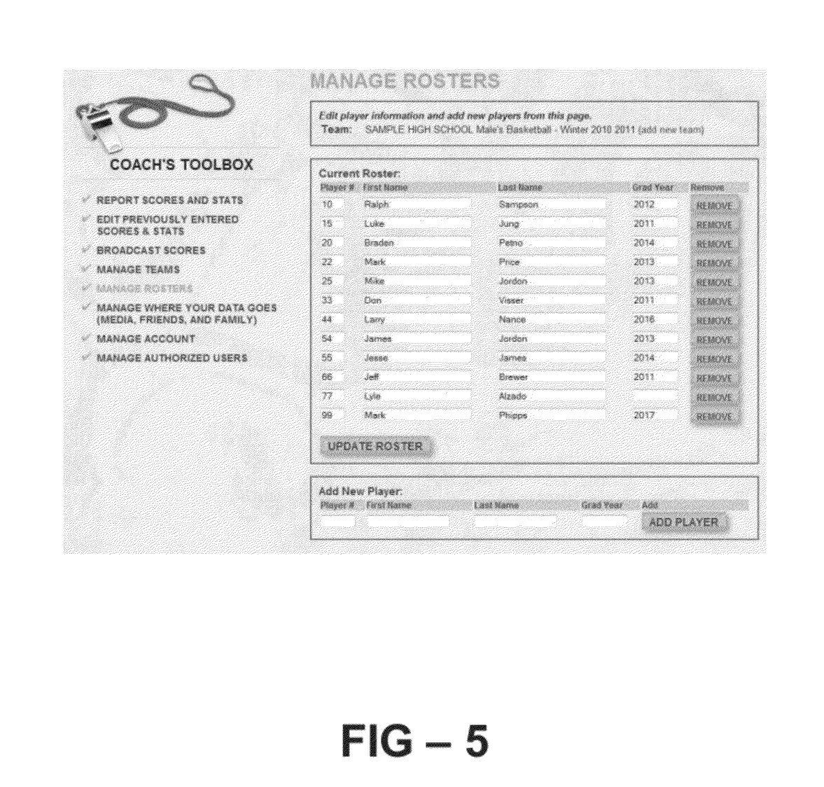

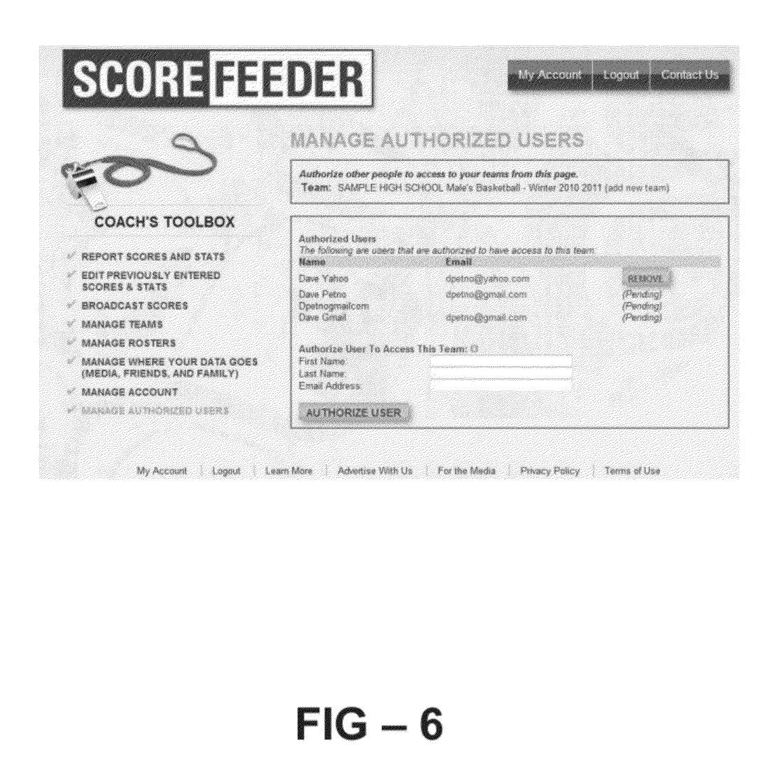

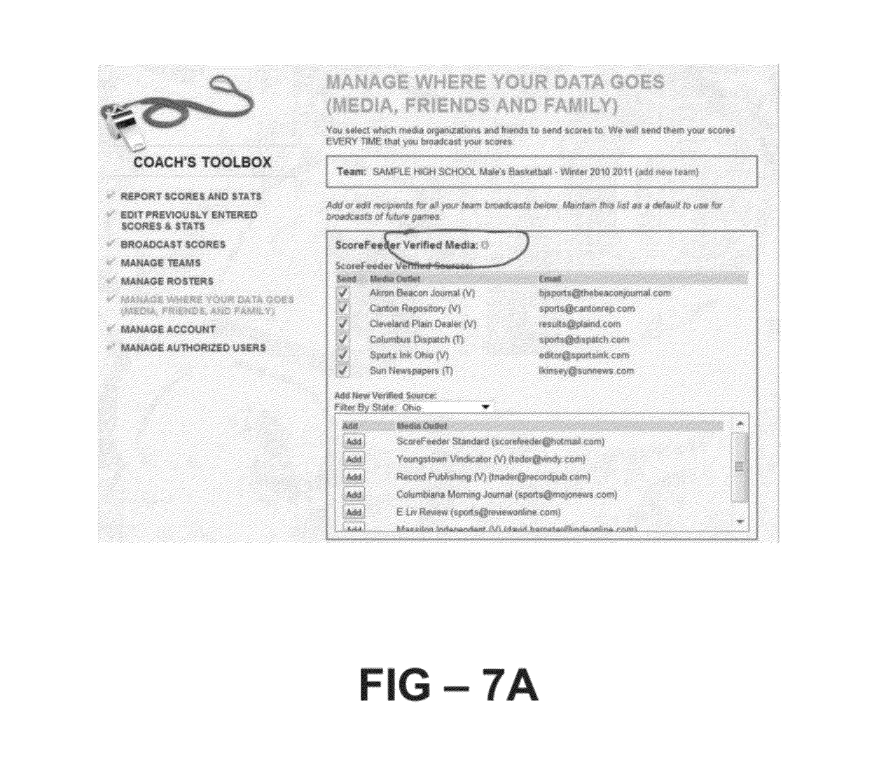

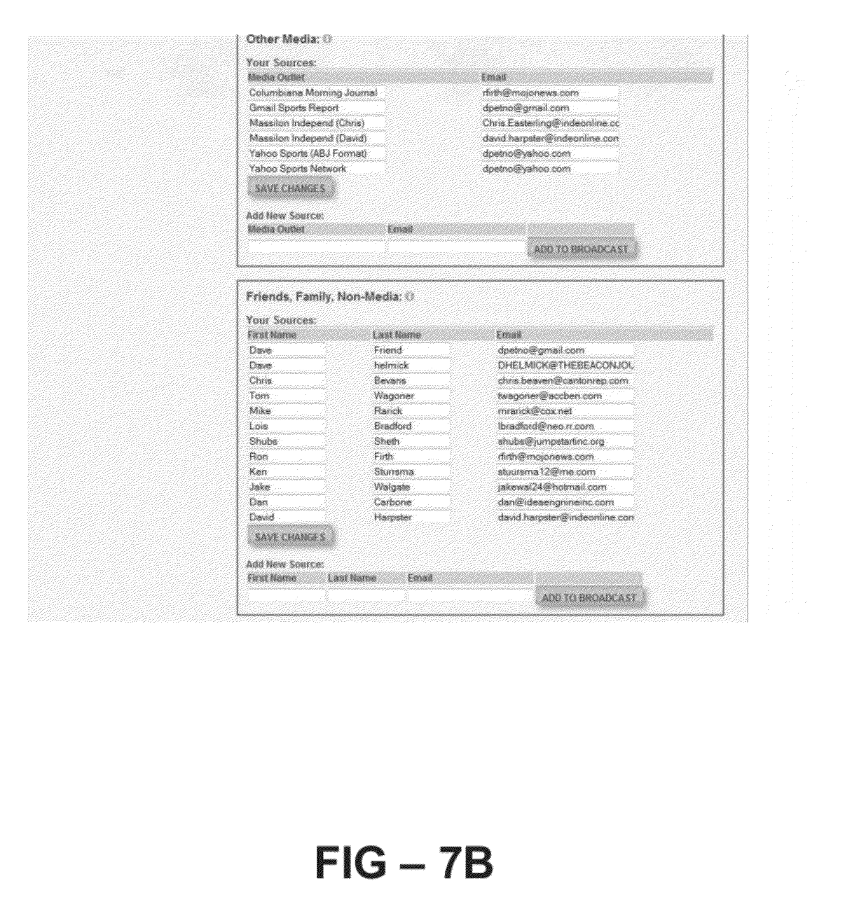

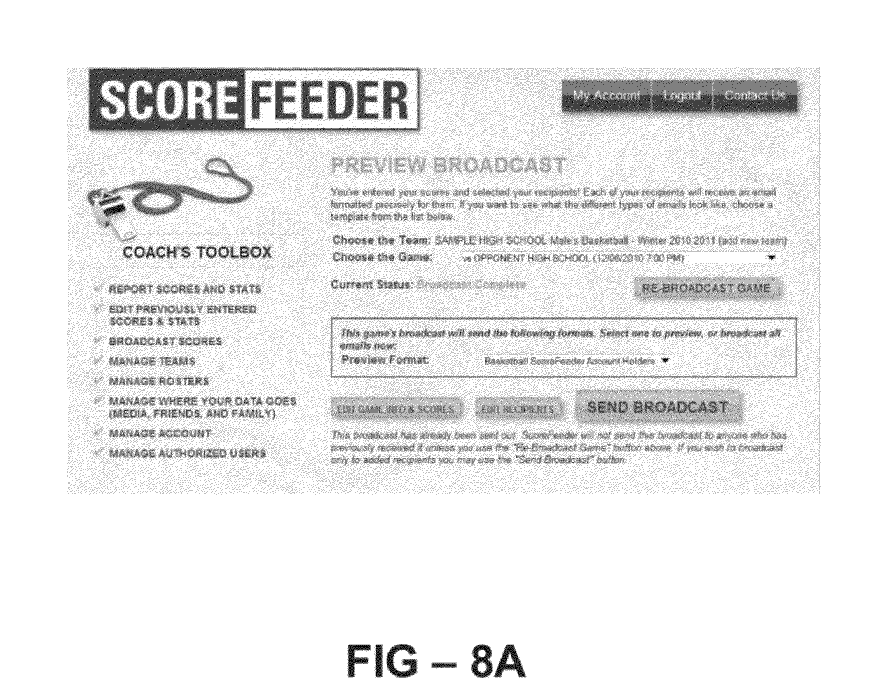

Referring now to the drawings wherein the showings are for purposes of illustrating embodiments of the invention only and not for purposes of limiting the same, and wherein like reference numerals are understood to refer to like components, FIG. 1 illustrates a system 10 for communicating information related to various sporting events. The system 10 includes a web or internet server 12 connected to the Internet 40, the global system of interconnected computer networks that use the standard Internet Protocol Suite (TCP/IP). The server 12 can be one or multiple servers. The server 12 can host or include a website 14, a database 16, and a communication server 18. The server 12 can include the necessary hardware and software to host the website 14, manage and operate the database 16, and host and operate the communications server 18. The website 14 can be accessed by any device 30 capable of accessing the Internet 40. The website 14 can communicate with the database 16. The website 14 can read information from and write information to the database 16. The device 30 can communicate with the server 12 directly or via the website 14. The server 12 can host or include a software utility 60 which provides access to the website 14, the database 16, and the communications server 18 for a system administrator. The software utility 60 can access additional functionality for the website 14, the database 16, and the communications server 18 that is not available to users accessing the website 14 via the Internet.

The database 16 can store sporting event information including, but not limited to, sporting event name and information, sporting event results, team or organization names, scores, and statistics, team member names, scores, and statistics, sporting event location, consolidated scores, statistical summaries, stats leaders, league membership or affiliation, coaches names and information, and officials and referees. The database 16 can store information from several different sporting events for several different sports. The database 16 can include login information, e.g. user name or email address and a password, for users to login and enter sporting event information. The database 16 can include user email addresses, team names, and sport types so that a user can receive emails containing sporting event information for a specific team.

The communication server 18 can send communication 20 from the server 12, the website 14, and the database 16. The communication server 18 can send out sporting event information in the following communications 20 including, but limited to, emails, text messages, multimedia messages, RSS or data feeds, or comma delimited output. In some embodiments, the communication server 18 is an email server. The communication server 18 can send one or more communications 20 containing information for a single sporting event to many different users.

According to some embodiments, the communication server 18 can send several communications or emails 20 with each communication or email 20 containing different information or content for the same the sporting event. For the same sporting event information, each email 20 can have a different arrangement, layout, or format. The sporting event information can be arranged or formatted in each email based upon a standard or customized template. For one non-limiting example, a first email 20 can contain information for a sporting event arranged in one format, and a second email 20 can contain information for the same sporting event arranged in a second format. For another non-limiting example, a first email 20 can contain summary information for a sporting event, and a second email 20 can contain detailed information for the same sporting event. For another non-limiting example, a first email 20 can contain summary or detailed information for a specific player or sub-set of players on the team, and a second email 20 can contain summary or detailed information for a different player or sub-set of players also on the team, in which both emails 20 include information from the same sporting event results.

The communication server 18 can send out several communications or emails with each communication or email including a different arrangement, layout, or format. The communication server 18 can send out the sporting event information in an unlimited number of different arrangements, layouts, or formats. Each recipient can receive an email 20 for the same sporting event in which the information contained in the email is in a different arrangement, layout, or format. For a non-limiting example, the recipients can receive the same or different information for the same sporting event in a different arrangement, layout, or format. For another non-limiting example, the recipients can receive different information or content about the same sporting event in the same, similar, or different layout or format. Thus, several different recipients can each receive email 20 containing different information or content for the same the sporting event in a customizable format. Each recipient can specify the format of the sporting event information contained in the communication or email sent to the recipient.

With reference now to all the FIGURES, the operation of the system 10 will be described according to some embodiments. Any user can access the homepage of the host website 14 from any device 30 capable of accessing the Internet 40. If the user is a coach or other team representative, the user can select the “COACH SIGN UP” button or hyperlink (“link”) to create an account and become a registered team representative. The team representative can enter his or her name, email address, title, and password. The team representative can select an existing school or team name or enter a new school or team name. The team representative can select a sport, a season, and a team gender. The team representative can select a conference, league, or other affiliation and whether to receive updates from other teams in the selected conference, league, or other affiliation. Team representatives can receive automatic updates of the sporting event information entered into the host website 14 by representatives of other teams in the same conference, league, or other affiliation. The team representative can select whether to receive automatic updates of the sporting event information from other teams in the same conference, league, or other affiliation, referred to as the “instant update” function. After entering all the applicable information, the team representative can select the “CREATE ACCOUNT” link.

Once a team representative has setup an account, the team representative can login using the account. After logging in, the team representative can report sporting event information, edit previously entered sporting event information, broadcast sporting event information, manage teams, manage rosters, manage information recipients including media and non-media recipients, manage the account, and manage authorized users of the account. The team representative can also manage and input the media outlets they would like to send data to by selecting verified media outlets from a list, or by entering other media outlets not included in the verified media list. The team representative can enter the sporting event information including, but not limited to, the date of the sporting event, the time of the sporting event, the home team, the winning team, the sporting event score, and team and individual statistics. The team representative can enter scores and statistics for the represented team, for the opposing team, or from both teams.

According to some embodiments, a team representative can login to an active account and select the following links from the COACH'S TOOLBOX (or the TOOLS & OPTIONS dropdown menu) including, but not limited to, REPORT SCORES AND STATS, EDIT PREVIOUSLY ENTERED SCORES & STATS, BROADCAST SCORES, MANAGE TEAMS, MANAGE ROSTERS, MANAGE WHERE YOU DATA GOES (MEDIA, FRIENDS, AND FAMILY), MANAGE ACCOUNT, and MANAGE AUTHORIZED USERS.

The team representative can select the “REPORT SCORES AND STATS” link from the COACH′S TOOLBOX. The team representative's team can automatically populate, or if the team representative is associated with several teams, then the team representative can select the appropriate team. The team representative can select the state and then either select or enter the name the opposing team or opponent. If the opposing team does not have an active representative, then the team representative can enter the contact information for the opposing team representative and the system 10 can then send a request inviting the opposing team representative to also become a user. The team representative can enter the date of the sporting event, the time of the sporting event, whether the team was home or away, and whether the sporting event result was a win or loss for the team. The team representative can select the “CREATE THIS GAME & BEGIN RECORDING STATS” link.

The team representative can enter overall wins and losses and conference wins and losses for both teams. The team representative can enter scoring per quarter, period, inning, match, or other appropriate interval of the scoring event. The team representative can enter any scoring for overtime, if appropriate. The team representative can enter team statistics and individual statistics for the represented team, for the opposing team, or for both teams. The team representative can view the team's roster and the opposing team's roster, if the opposing team also has a registered team representative. The team representative can add participants to either team to include participants not in a team's roster. The team representative can enter free form text in a “Game Description” field. This can include a summary of the game, any highlights of the game, or any other information the team representative desires to include with the game scores and statistics. The team representative can select the “CONTINUE TO BROADCAST SCORES” link to navigate to the broadcast scores web pages. In some embodiments, a representative from the opposing team must verify and approve the sporting event information before the information can be broadcasted.

The team representative can select the “EDIT PREVIOUSLY ENTERED SCORES & STATS” link from the COACH'S TOOLBOX. The team representative can then select a previously entered sporting event or game result and edit the information, as previously described.

The team representative can select the “BROADCAST SCORES” link from the COACH′S TOOLBOX. The team can automatically be selected based upon the team representative, or the team representative can select a team or add a new team. The team representative can select a sporting event or game result for the selected team. The current status of the broadcast can be displayed as, for example, not broadcast, broadcast complete, or re-broadcast complete. If the sporting event information was previously broadcast, the team representative can select the “RE-BROADCAST GAME” link to re-broadcast the information to all recipients again. The team representative can preview formats of the sporting event information for each recipient or group of recipients. Each recipient can receive the sporting event information in a different format. The team representative can select the “EDIT RECIPIENT” link to add or remove formats, recipients, or both. The team representative can select the “EDIT GAME INFO & SCORES” link to update the sporting event information before broadcasting or re-broadcasting the information.

In some embodiments, the team representative can select standard media outlets, verified media outlets, and other media outlets as recipients. In other embodiments, the team representative cannot add or remove the standard media outlets. Any media outlet or other association can have the status of a standard media source for any state, school, sport, team, or organization. A standard media outlet or source is a media outlet or other association that has requested to automatically receive information on any or all teams in a given sport, state, school, or gender. Each standard media outlet can be setup to receive sporting event information for a team, or for multiple teams, regardless of whether the team representative selects the standard media outlet as a recipient. The standard media outlets can receive sporting event information each time the information is broadcasted for a team without the team representative selecting the standard media outlet. All of the standard media outlets can receive the sporting event information in the same format or in different formats. The standard media outlet can be entered and selected with the software utility 60, shown in FIG. 1.

A system administrator or other authorized user can login and use the software utility 60 to manage verified media outlets and standard media outlets. The software utility can add, edit, or delete verified media outlets and standard media outlets. The software utility can display a list of all verified media outlets with a marking or designation to indicate which verified media outlets are also standard media outlets. In one embodiment, the designation “pushed” indicates that the verified media outlet is also a standard media outlet. The authorized user can select any verified media outlet and make it a standard media outlet. The authorized user can select a verified media outlet and then select the “Required For Future Broadcasts:” check box to make it a standard media outlet. This media outlet can now receive all of the broadcasts from any of the organizations who meet the media outlet's criteria, for example, the school, state, sport, gender, or conference. The software utility 60 can create an unlimited number of custom formats for each media outlet or recipient. Each media outlet or recipient can receive the sporting event information in a different format. Each media outlet or recipient can receive the sporting event information for each team, organization, sport, state, gender, and conference in different formats.

The verified media outlets or sources are media outlets which have previously been screened. Any media outlet can provide a format or template to receive the sporting event information and an active email address. After a communication or email including the specified format, layout, and content has been received, confirmed, and approved by the media outlet, the media outlet can become a verified media outlet. The team representative can select a verified media outlet without having to enter the contact or email information. The team representative can select one or more verified media outlets from a list by selecting the “Add” button. The list can be filtered by state, conference, league, region, or other association.

The team representative can enter other media outlets or sources by entering a name and an email address for an other media outlet and selecting the “ADD TO BROADCAST” link. The team representative can remove any or all of the other media outlets by un-selecting them from the list of other media outlets. The other media outlets can receive the broadcasts in a default or custom format. The team representative can save the list of other media outlets for future broadcasts of sporting event information for that team or organization. The team representative can select the “Save for future broadcasts” check box to save the list of other media outlets for future broadcasts. In addition, any media outlet, whether verified or not, can access the public subscription page of the website and sign up to receive broadcasts of sporting event information for one or more teams or organizations. The media outlet or other association can automatically receive sporting event information for all of the teams that they have selected, regardless of whether the coach selects or submits them as a recipient.

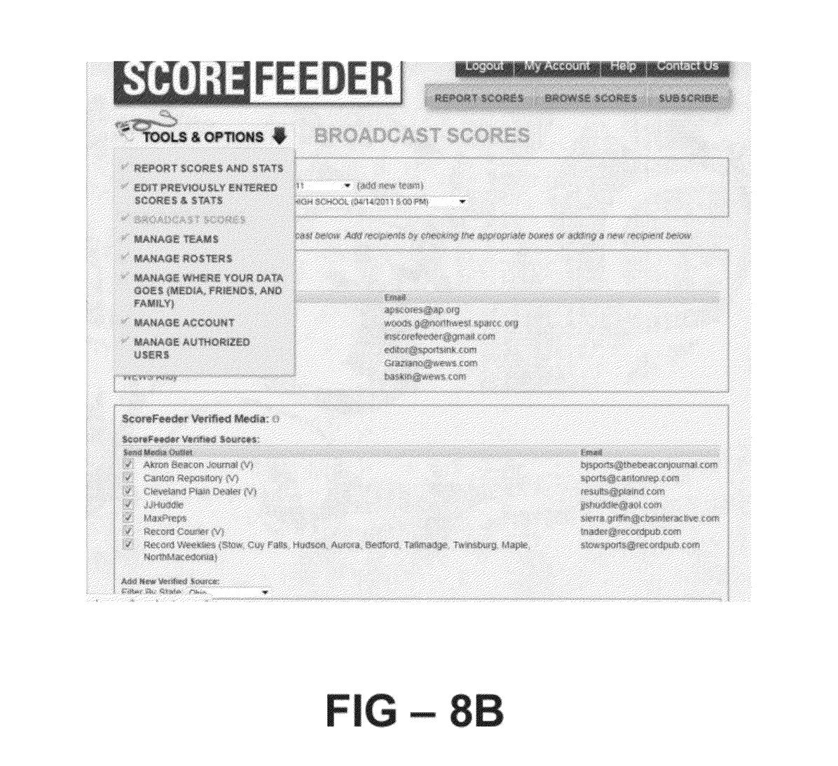

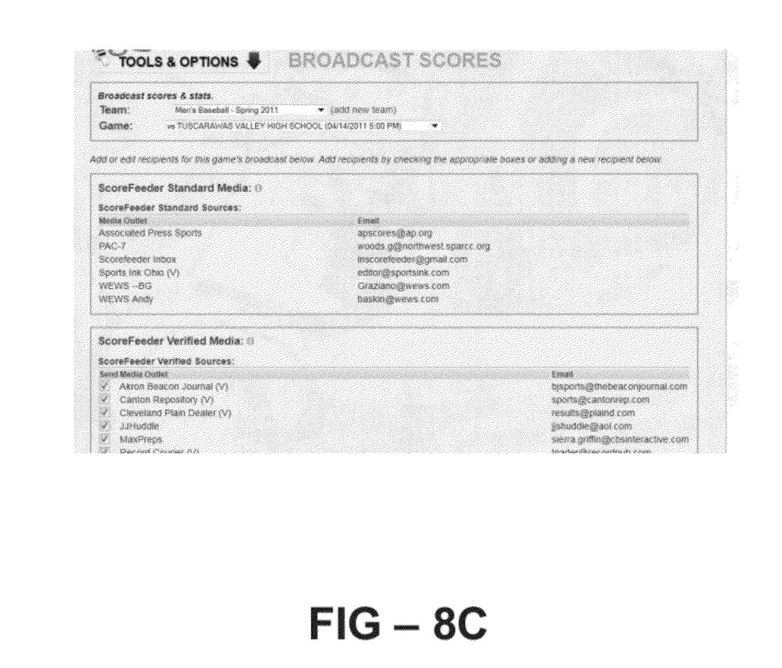

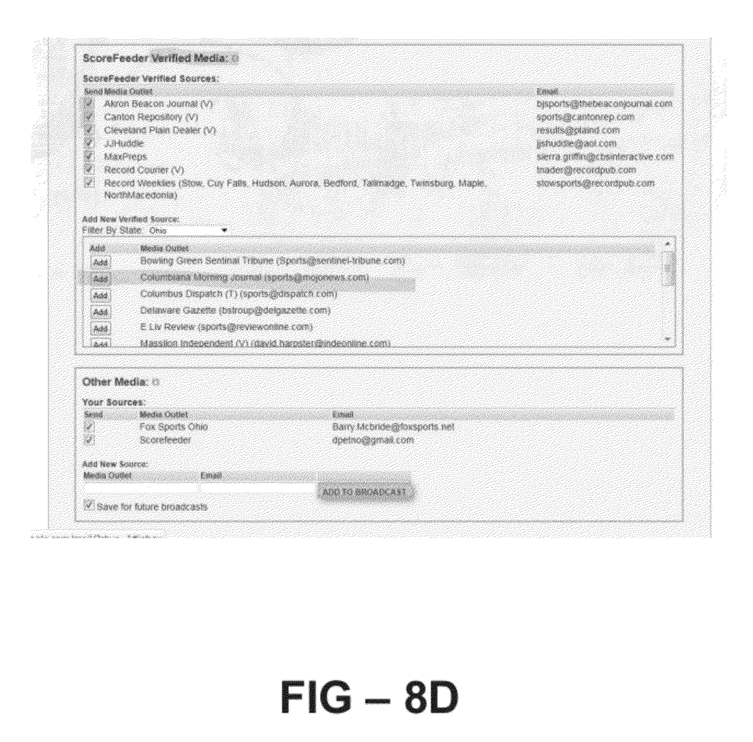

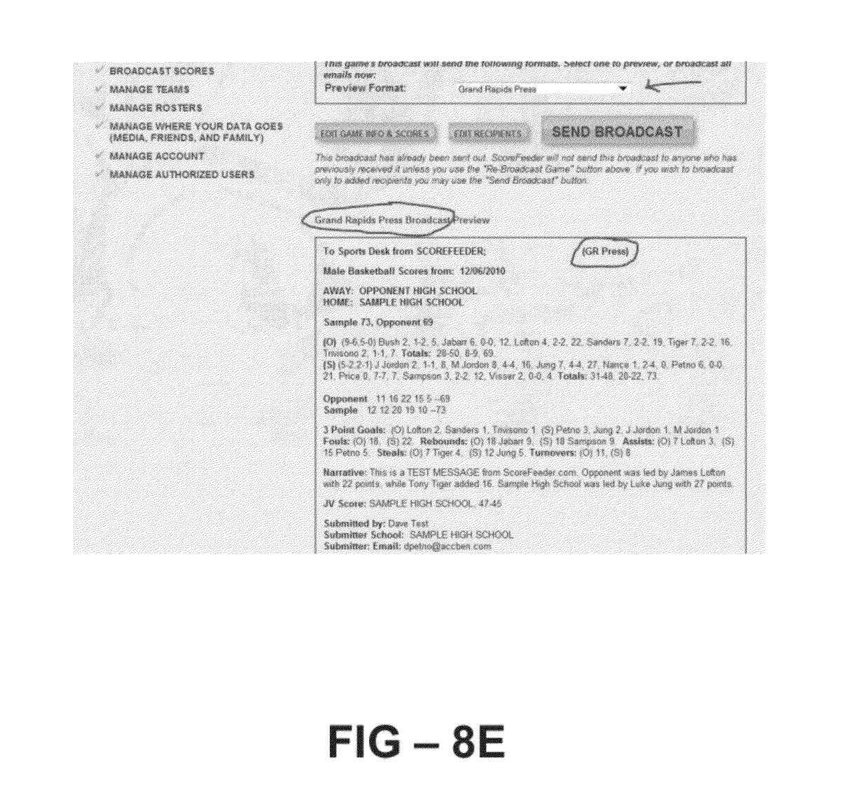

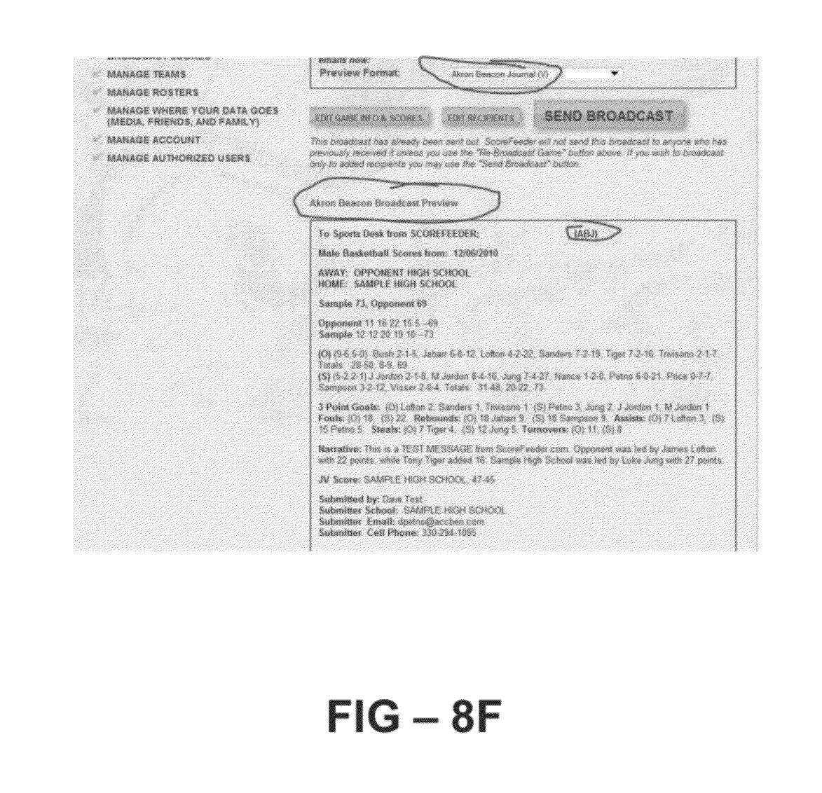

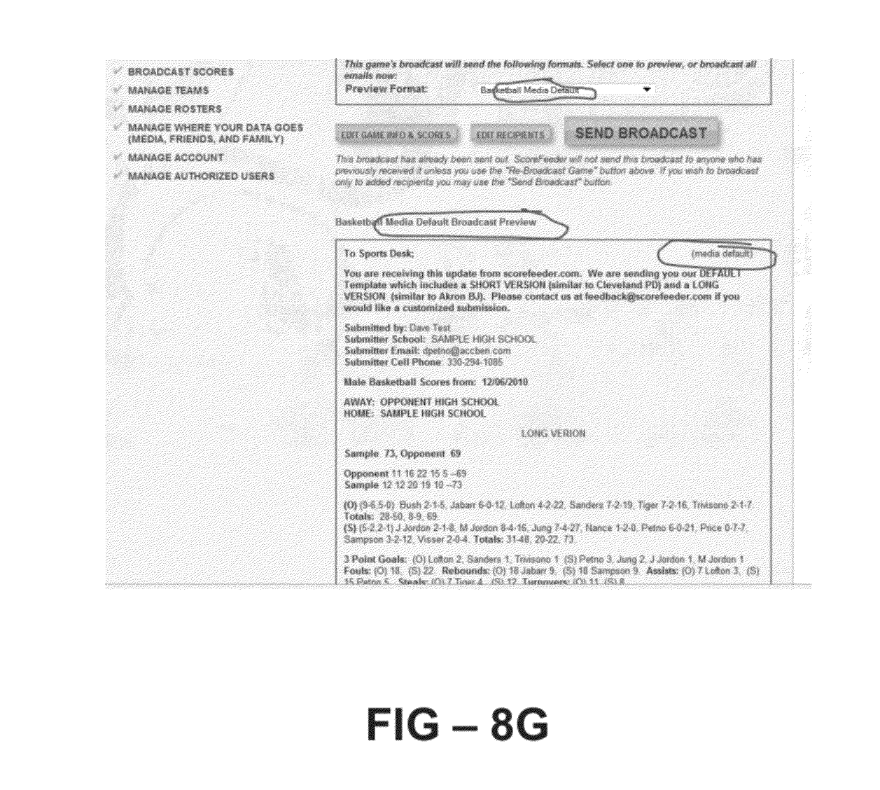

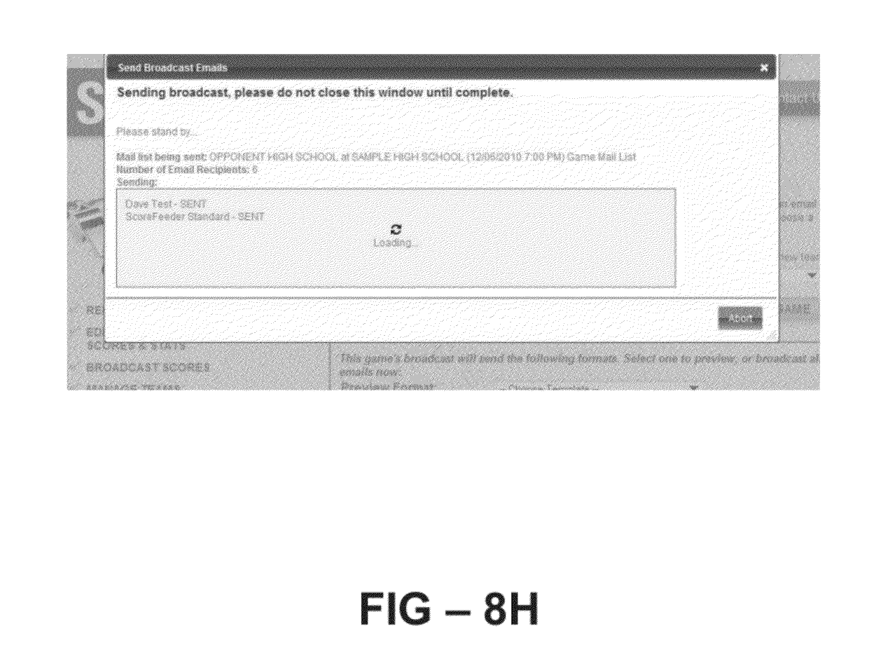

Once the team representative is satisfied with the sporting event information, the formats, and the recipients, then the team representative can select the “SEND BROADCAST” link or the “RE-BROADCAST GAME” link. The “SEND BROADCAST” link sends the sporting event information to recipients who have not yet received the broadcast. If both teams have registered team representatives who have entered roster data and/or media and other recipient selections, the broadcast can send the sporting event information to the recipients of both teams, who have not yet received the broadcast. If this is the first broadcast of the information, then selecting the “SEND BROADCAST” link sends the selected recipients the sporting event information in the specified formats. If the sporting event information was already broadcast, then selecting the “SEND BROADCAST” link sends the sporting event information in the specified formats to only new recipients. The “RE-BROADCAST GAME” link sends the sporting event information to all recipients regardless of whether they received the original broadcast or a previous re-broadcast. If both teams have registered team representatives, the re-broadcast can send the sporting event information to all recipients of both teams. The host website 14 presents a display to the team representative with the status and the results of the broadcast or re-broadcast. As shown in FIG. 8H, the team representative can view the status of each communication or email being sent to each recipient. In some embodiments, the host website 14 can slowly release the emails rather than sending them all at once in order to avoid appearing as spam. The team representative can select the “Abort” link on the display to terminate the broadcast or re-broadcast before the sporting event information has been sent. The “SEND BROADCAST” link or the “RE-BROADCAST GAME” link can also send the sporting event information to the other team representatives in the same conference, league, or other affiliation.

The team representative can select the “MANAGE TEAMS” link from the COACH'S TOOLBOX. The team representative can add, remove, and update teams associated with or under the control of the team representative.

The team representative can select the “MANAGE ROSTERS” link from the COACH'S TOOLBOX. The team representative can add, remove, or update players or participants to the team's roster.

The team representative can select the “MANAGE WHERE YOU DATA GOES (MEDIA, FRIENDS, AND FAMILY)” link from the COACH'S TOOLBOX. The team representative can select a verified source or media outlet from the list of verified sources. Each verified source can specify a format in which the source receives the sporting event information. In one embodiment, the verified media sources can receive an email with the sporting event information in custom format. The team representative can add additional or other media outlets which were not included in the list of verified sources. In some embodiments, the other media outlets receive the sporting event information in a standard, default, or customized format. In one embodiment, the other media outlets receive an email with the sporting event information in a standard format. In other embodiments, the team representative can select an existing sporting event information format or define a new sporting event information format for each additional media outlet receiving the broadcast. The team representative can add additional non-media sources including, but not limited to, family, friends, and acquaintances. In some embodiments, the non-media sources receive the sporting event information in a standard, default, or customized format. In other embodiments, the team representative can select an existing sporting event information format or define a new sporting event information format for each non-media source receiving the broadcast. When the team representative or other authorized user broadcasts or re-broadcasts the sporting event information, the selected verified media sources, the identified additional media outlets, and the identified non-media sources receive the broadcast in the respective formats.

The team representative can select the “MANAGE ACCOUNT” link from the COACH'S TOOLBOX. The team representative can update account information including, but not limited to, the contact email address.

The team representative can select the “MANAGE AUTHORIZED USERS” link from the COACH'S TOOLBOX. The team representative can add, remove, or update authorized users of a team. The team representative can add one or more authorized users by providing the name and email address for each user and then selecting the “AUTHORIZE USER” link Authorized users can input, revise, and broadcast sporting event information for the team.

Any user can access the website and select the “BROWSE SCORES” link to view sporting event information for one or more teams. The user can select any state and any team within the selected state to view the team's sporting event information. After selecting the state and the team, the user can select the “PRODUCE TEAM FEED” link to see the sporting event information for the selected team. The results from several sporting events or games the team participated in can be listed individually and summarized.

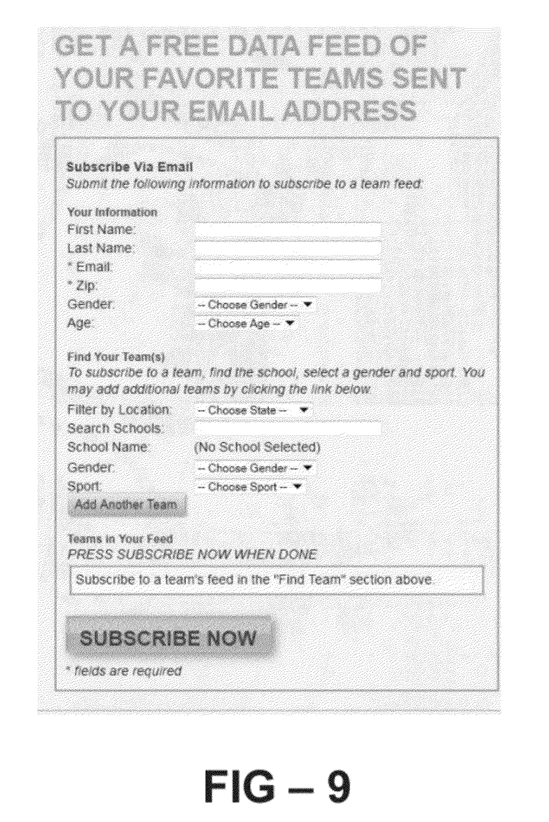

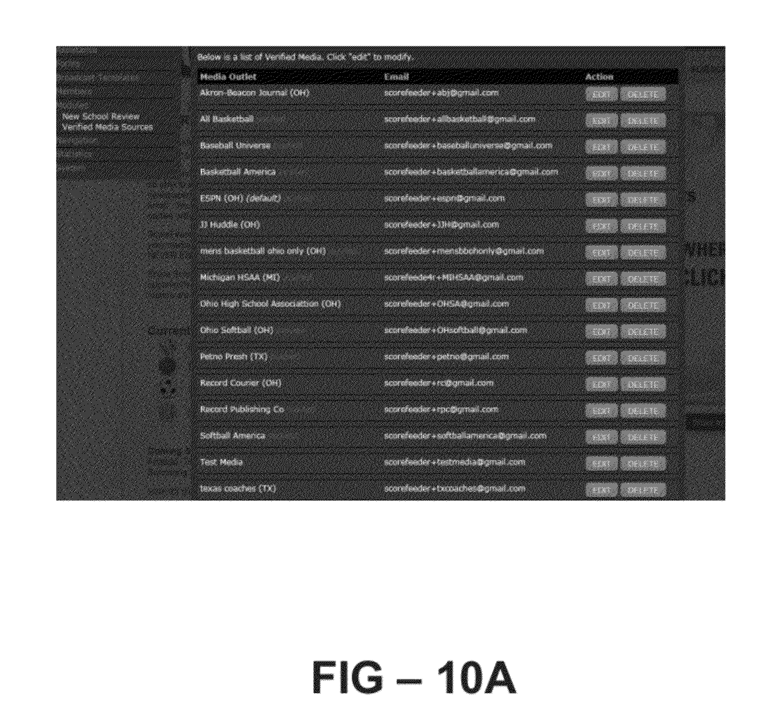

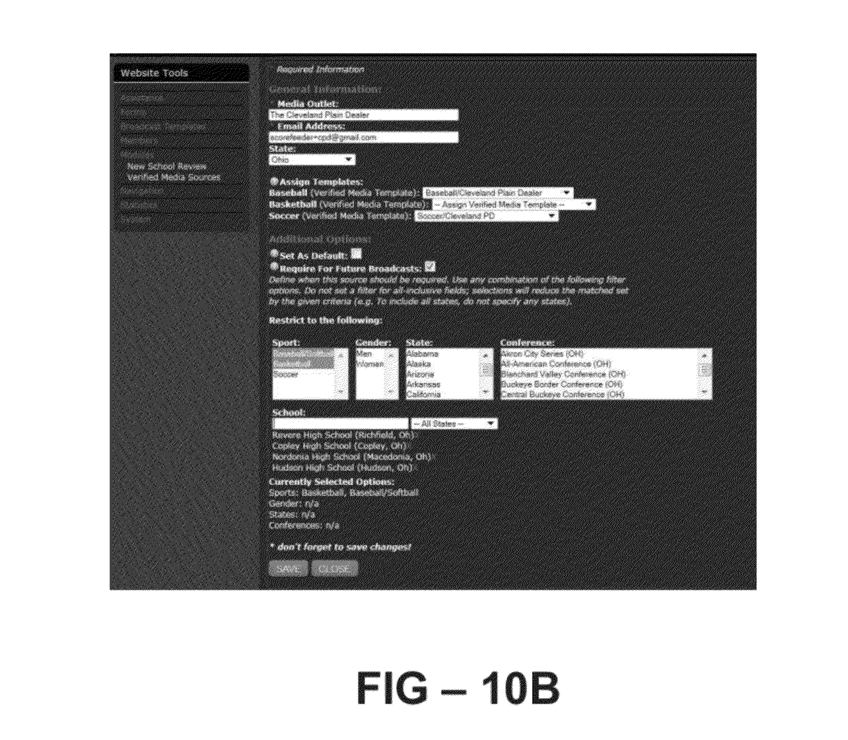

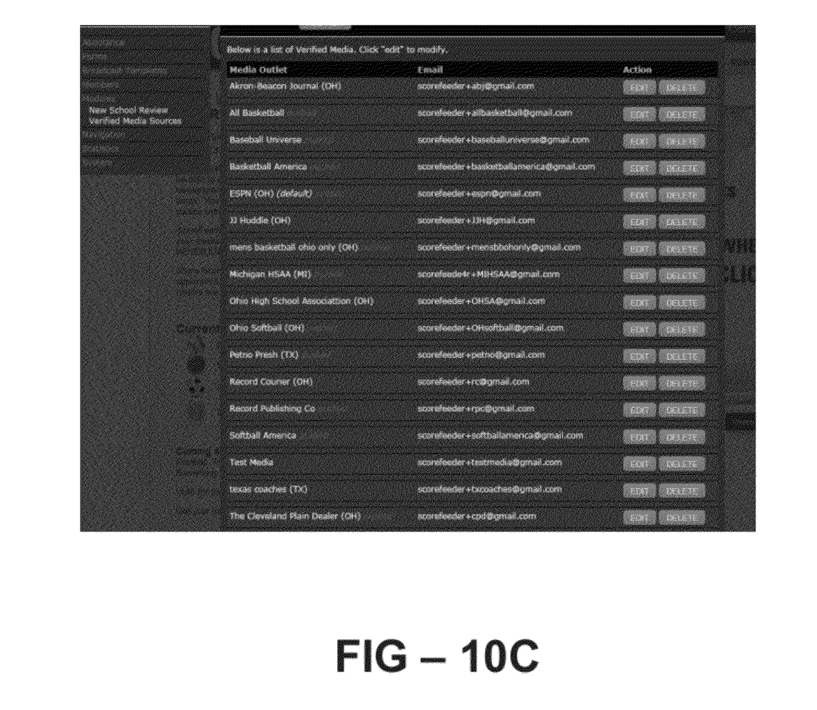

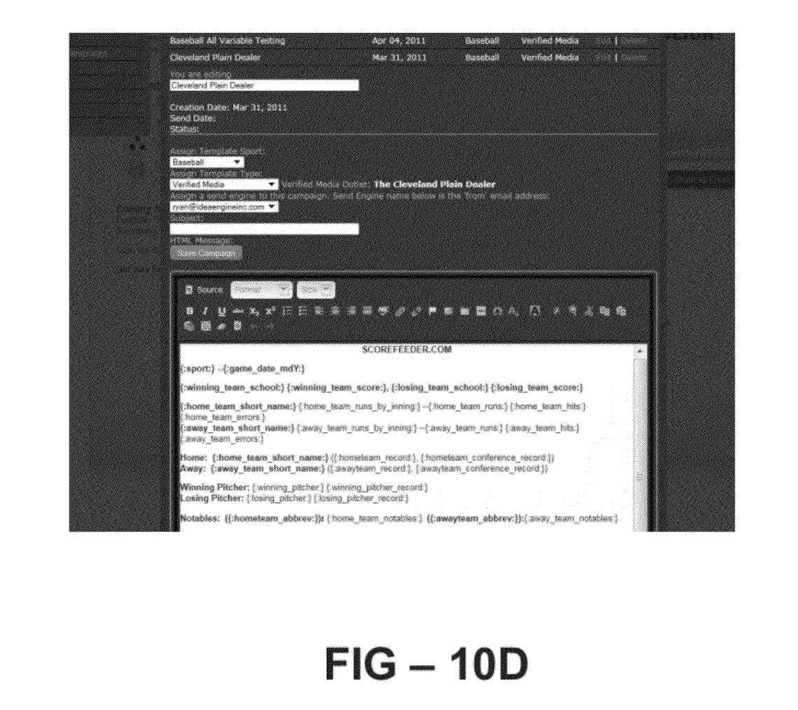

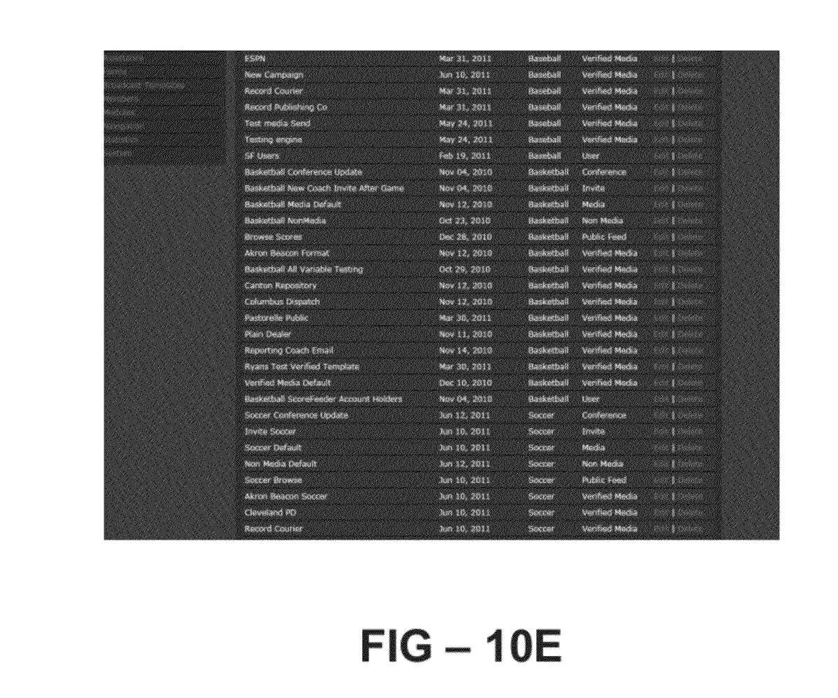

Any user can access the website and select the “SUBSCRIBE” link to receive sporting event information for one or more teams when the information is broadcasted. After selecting the “SUBSCRIBE” link, the user can view the public subscription web page, as shown in FIG. 9. The user can enter an email address to receive the sporting event information. The user can also enter the user's zip code, name, gender, and age or age group. The user can select the state and enter a school or team name. The system searches the database for one or more matches. The system displays the match or matches and the user selects the appropriate team. The user can select the team gender and the team sport (e.g. basketball, baseball, softball, football, soccer, golf, track, etc.). The user can subscribe to multiple teams by selecting the “Add Another Team” link. After the user has selected the team or teams, the user can select the “SUBSCRIBE NOW” link to subscribe to the broadcast of the selected team or teams. When the sporting event information is broadcasted for the selected team or teams, the user will receive the information in a standard, custom, or customizable format. In some embodiments, the user can either select an existing format or template or define a new format or template for the content and arrangement of the sporting event information.

The system 10 can include one or more FACEBOOK® applications (apps) 70. The system 10 can include a FACEBOOK® app 70 in which the app posts sporting event information in FACEBOOK®. The system 10 can include a FACEBOOK® app 70 in which a user can select one or more schools or teams and follow them. The user's FACEBOOK® profile photo can display with a list of other users who are also following the same school or team in a section labeled, for example, “The Bleachers” or “The Fans.” The user can view the game results of all teams for the selected school or schools. The user can “Like” an individual game result. The user can post a game result to a FACEBOOK® wall. The user can share the score with other FACEBOOK® users.

The FACEBOOK® app can display as a SCOREFEEDER™ icon on the user's profile page or wall. When the user selects the SCOREFEEDER™ icon, the user is directed to the SCOREFEEDER™ FACEBOOK® app page, where the most recent sporting event information is displayed for the schools or teams the user is following. The user can select any number of schools or teams to follow and all the selected schools or teams are listed in the “My Schools” list. When the user selects any of the schools or teams in the “My Schools” list, the user is directed to the most recent sporting event information submitted via FACEBOOK®. The user can select a “Share” button to post sporting event information to the user's wall.

The device 30 can include a mobile application, or mobile app 50. The device 30 can run a mobile operating system software which provides a platform for mobile apps 50 to operate. The mobile app 50 can allow users of devices 30 to utilize a customized screen format to communicate with the server 12, the website 14, and the database 16 to input and edit sporting event information and broadcast the sporting event information. The server 12, the website 14, or the database 16 can include an Application Programming Interface (API). The mobile app 50 can communicate with via the API and can input and edit sporting event information and broadcast sporting event information via the API. Thus, the device 30 can communicate with the server 12 by using a web browser or via the API using the mobile app 50.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

We claim:

1. A method of communicating information related to a sporting event information comprising the steps of:
accessing a website;
entering a first sporting event information into the website;
broadcasting the first sporting event information via a plurality of communications, wherein a first communication contains the first sporting event information in a first format and a second communication contains the first sporting event information in a second format.

2. The method of claim 1 wherein the first communication is a first email and the second communication is a second email.

3. The method of claim 1 wherein the step of broadcasting the first sporting event information further comprises:
automatically sending the first sporting event information via email after the first sporting event information has been entered.

4. The method of claim 1 wherein the step of broadcasting the first sporting event information further comprises:
automatically sending the first sporting event information via email after the first sporting event information has been entered and verified.

5. The method of claim 1 wherein after the step of entering a first sporting event information, the method further comprising the steps of:
arranging the first sporting event information into a first format;
arranging the first sporting event information into a second format.

6. The method of claim 1 wherein after the step of entering a first sporting event information, the method further comprising the steps of:
modifying a first email with the first sporting event information in a first format;
modifying a second email with the first sporting event information in a second format.

7. The method of claim 1, wherein the step of broadcasting further comprises:
wherein a third communication contains the first sporting event information in a third format, a fourth communication contains the first sporting event information in a fourth format, a fifth communication contains the first sporting event information in the first format, and a sixth communication contains the first sporting event information in the second format.

8. The method of claim 1 wherein after the step of entering a first sporting event information, the method further comprising the steps of:
selecting and arranging a first subset of the first sporting event information for a first format;
selecting and arranging a second subset of the first sporting event information for a second format.

9. A method of communicating information related to a sporting event information comprising the steps of:
accessing a website;
associating a first recipient to a first organization and a second recipient to a second organization;
entering a first sporting event information for the first and second organizations into the website;
broadcasting the first sporting event information via a plurality of communications to a plurality of recipients, wherein the first recipient receives a first communication with the first sporting event information in a first format and the second recipient receives a second communication with the first sporting event information in a second format.

10. The method of claim 9 wherein the first communication is a first email and the second communication is a second email.

11. The method of claim 9 wherein the step of broadcasting the first sporting event information further comprises:
automatically sending the first sporting event information via email after the first sporting event information has been entered.

12. The method of claim 9 wherein the step of broadcasting the first sporting event information further comprises:
automatically sending the first sporting event information via email after the first sporting event information has been entered and verified.

13. The method of claim 9 wherein after the step of entering a first sporting event information, the method further comprising the steps of:
arranging the first sporting event information into a first format;
arranging the first sporting event information into a second format.

14. The method of claim 9 wherein after the step of entering a first sporting event information, the method further comprising the steps of:
modifying a first email with the first sporting event information in a first format;
modifying a second email with the first sporting event information in a second format.

15. The method of claim 9 further comprising the steps of:
associating a first media outlet with a first organization;
associating a second media outlet with a second organization;
associating a third media outlet with the first organization;
associating a fourth media outlet with the second organization;
entering a first sporting event information for the first and second organizations;
broadcasting the first sporting event information to a plurality of recipients, wherein the first media outlet receives a third communication containing the first sporting event information in a third format, the second media outlet receives a fourth communication containing the first sporting event information in a fourth format, the third media outlet receives a fifth communication containing the first sporting event information in the fourth format, and the fourth media outlet receives a sixth communication containing the first sporting event information in the third format.

16. The method of claim 9 wherein after the step of entering a first sporting event information, the method further comprising the steps of:
selecting and arranging a first subset of the first sporting event information for a first format;
selecting and arranging a second subset of the first sporting event information for a second format.

17. A system for communicating information related to sporting events comprising:
a server hosting a website;
a database in communication with the server containing a plurality of sporting event information including a first sporting event information; and
an email server in communication with the database;
wherein the email server can send a first email with the first sporting event information in a first format and a second email with the first sporting event information in a second format.

18. The system of claim 17, wherein the email server creates the first format based upon a first setting and creates the second format based upon a second setting.

19. The system of claim 17, wherein the first format is a first subset of the first sporting event information, and wherein the second format is a second subset of the first sporting event information.

20. The system of claim 17, wherein the first format is a first arrangement of the first sporting event information, and wherein the second format is a second arrangement of the first sporting event information.
